(19) United States
(12) Patent Application Publication
(10) Pub. No.: US 2008/0029680 A1
(43) Pub. Date: Feb. 7, 2008

(54) ADJUSTABLE SHIM

(76) Inventor: Brian Maxson, Riverside, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/459,175

(22) Filed: Jul. 21, 2006

(51) Int. Cl. F16M 5/00

(52) U.S. Cl. 248/637

(57) ABSTRACT

An adjustable shim for aligning a component of a manufactured device comprising plates for mounting or abutting the shim to the component to be aligned and to a stationary portion of the device, an adjustable retainer wall extending between the plates and enclosing a volume filled with thermoplastic material having a melting temperature that exceeds the operating temperature of the component to be aligned. In operation, the component to be aligned is mounted to the shim and the shim is mounted to a stationary portion of the manufactured device and the device is then positioned on a tool defining a predetermined alignment of the component. The thermoplastic material is then heated to its melted state and the alignment of the component is adjusted to the predetermined alignment set by the tool while the thermoplastic material is in its melted state. The thermoplastic material is then cooled to fix the shim and component in the adjusted position.

### FIELD OF THE INVENTION

The present invention relates generally to shims, and more particularly to an adjustable shim that facilitates alignment of components of manufactured devices.

### BACKGROUND OF THE INVENTION

The purpose of a shim is to compensate for variations in mechanical components of a manufactured object which, when assembled, results in some unacceptable variation in a particular physical relationship of those components. Typically, during manufacture, some sort of ‘jig’, tool or test fixture indicates the proper alignment of the components of the object. The object being manufactured is placed on the test fixture and one or more shims are positioned to achieve proper alignment between the components. The position of the components is then typically fixed using some sort of fastener, adjustment screw, or the like, or the shim is left in place. This system and method of alignment tends to be time consuming and difficult, and often less than completely successful.

Therefore, it would be desirable to provide a system and method that facilitates the alignment of mechanical components of manufactured objects.

### SUMMARY OF THE INVENTION

Improved methods, systems and apparatus for adjusting the alignment of parts in a manufactured object, either during manufacture or during use, are provided in this section by the way of exemplary embodiments. These embodiments are examples only and are not intended to limit the invention.

The present disclosure is directed to an improved adjustable shim for aligning components of a manufactured device. In one embodiment, the shim preferably comprises first and second mounting plates for mounting the shim to or abutting a component to be aligned and for mounting the shim to or abutting a stationary portion of the device, such as a chassis or the like. Extending between the first and second plates is an adjustable retainer wall enclosing a volume bounded by the retainer wall and first and second plates. The bounded volume is preferably filled with thermoplastic material having a melting temperature that exceeds the operating temperature of the component to be aligned.

In an alternative embodiment, the shim includes a second or interior adjustable retainer wall extending between the first and second plates. The volume enclosed and bounded by the retainer walls and plates preferably has an elongate annular shape. In this configuration, the shim is mountable over a shaft.

In operation in one embodiment, the component to be aligned is mounted to or abutted by the adjustable shim and the shim is mounted to or abuts another portion of the manufactured device that is preferably stationary, such as a chassis, or the like. Once the shim is in place, the device is positioned on a tool defining a predetermined alignment for the component. The thermoplastic material positioned within the enclosed volume of the shim is then heated to its melted state or liquid phase. Once the thermoplastic is heated to its melted state, the alignment of the component is adjusted to the predetermined alignment set by the tool. The thermoplastic material is then cooled to fix the shim and component in the adjusted position.

In another embodiment, the shim includes state or phase indicators to indicate when the thermoplastic had reached a melted state or liquid phase.

In a further embodiment, the shim is pre-tensioned to enable automatic component adjustment by moving the first and second plates relative to one another in a predetermined direction when the thermoplastic material is in a melted state.

In yet a further embodiment, the shim includes an embedded heating element to melt the thermoplastic material. Preferably, the heating element is an electrical coil and the adjustable shim is electrically activated.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1A is a perspective view of an embodiment of an adjustable shim.

FIG. 1B is a plan view of the adjustable shim in FIG. 1A.

FIG. 2A is a perspective view of another embodiment of an adjustable shim with a heating element positioned within the shim.

FIG. 2B is sectional view of the adjustable shim in FIG. 2A taken along line 2B-2B.

FIGS. 3A and 3B are plan views of embodiments of pre-tensioned adjustable shims.

FIG. 4A is a plan view of a further embodiment of an adjustable shim having an indicator for indicating the state of the thermoplastic material.

FIG. 4B is a perspective view of another embodiment of an adjustable shim having an indicator for indicating the state of the thermoplastic material.

FIG. 5A is a plan view of yet another embodiment of an adjustable shim having a heating element mounted to one of the mounting plates.

FIG. 5B is a sectional view of the adjustable shim in FIG. 5A taken along line 5B-5B.

FIGS. 6A and 6B are plan views of an adjustable shim in adjusted positions.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Devices, systems and methods for adjusting the alignment of parts in a manufactured object, either during manufacture or during use, are described herein. Turning in detail to the figures, a shim whose dimensions can be adjusted is described along with some related features that make such a shim useful in the production of products comprised of components whose physical alignment is critical. The purpose of such a shim is like that of any other shim—to compensate for variations in mechanical components which, when assembled, result in some unacceptable variation in a particular physical relationship of those components. The shim provides a mechanism and method for adjusting alignment of parts or components in a manufactured object, either during manufacture or during use. The shim is essentially an “adjustable shim.” In the manufacturing environment it can be used during final assembly to align two parts for the life of the product. However, in its adjustable implementation, it provides a means by which the manufactured object can adjust itself when it detects a mis-alignment.

During manufacture, some sort of ‘jig’, tool or test fixture is used to indicate the proper alignment of the component. The object being manufactured is then placed on the test fixture and one or more shims are softened, melted, or made pliable by the application of heat through electric current or the like, allowing the components to settle into the proper positions as defined by the test fixture. The heat is then removed allowing the shims to harden into a fixed position.

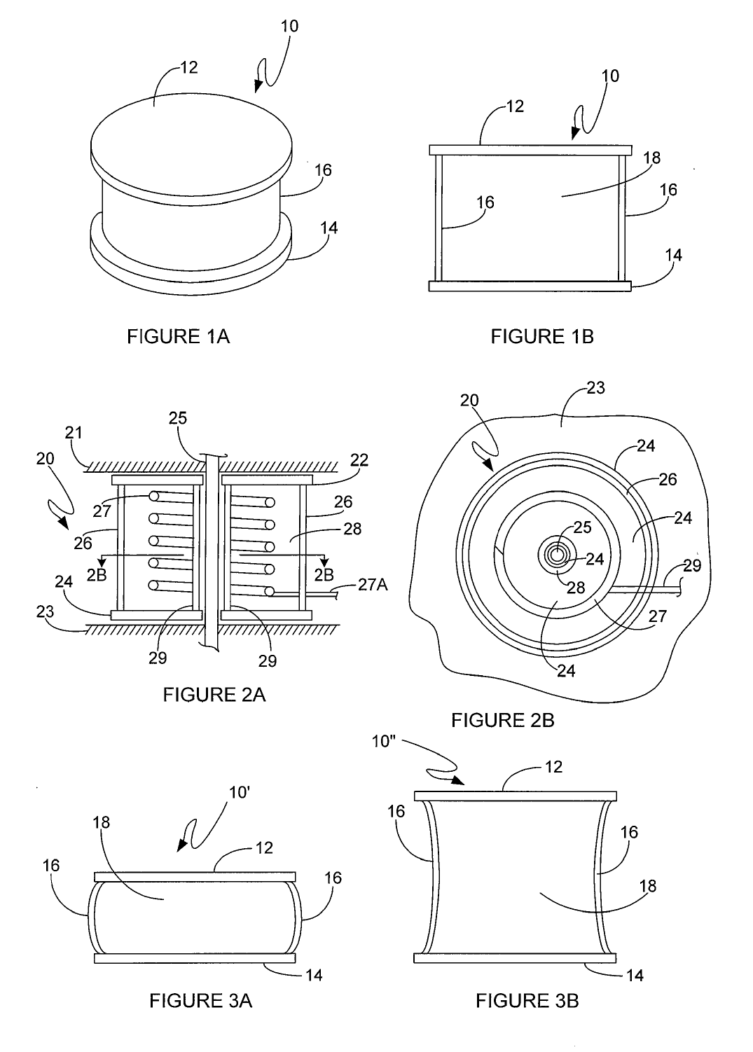

The basic components of the shim 10 are, as depicted in FIGS. 1A and 1B, a top rigid element or plate 12, to which the component to be aligned, e.g., an image engine of a television, can be mounted or abutted, a bottom rigid element or plate 14, which can be mounted to or abut a non-moving component or stationary portion of the manufactured object, e.g., a chassis of the television, a volume of thermoplastic material 18 separating plates 12 and 14, a container or retainer wall 16 extending between the plates 12 and 14 and enclosing the thermoplastic materials. The plates 12 and 14 and retainer wall 16 enclose a volume in which the thermoplastic material 18 is positioned. The retainer wall holds the thermoplastic material 18 in place when it is in a liquid phase or melted state. Preferably, the retainer wall 16 is formed from a pliable material making it flexible. In order to adjust the shim 10, a source of heat sufficient to melt the thermoplastic material 18 is directed at the shim 10 during production when components are held in the test fixture. The components are allowed by the shim(s) 10 to ‘relax into place,’ after which the source of heat is removed. The components are held in place until the thermoplastic material 18 completely solidifies.

FIGS. 2A and 2B illustrate a shim 20 having a ‘washer-shape’ or annular shape with top and bottom annular plates or washers 22 and 24 that slide over a central shaft 25 such as a mounting bolt. The purpose of this shim is to align a movable member 21 with respect to a fixed member 23 during manufacture, for example to compensate for the tolerances of other components. In the melted state the ‘washer’ shaped shim 20 can be compressed or stretched along the axis of the shaft 25, as required, to properly align the components. In this case, the two washers 22 and 24 are separated by a solid polymer material 28 in the general shape of a toroid or cylindrical annulus with an embedded heating element 27 and lead 27A extending out through the outer retainer wall 26. Alternatively, the ends of the heating element 27 could attach to washer 22 and 24 if the plates are conductive. The polymer material 28 is formulated to melt at a temperature well above what the finished product would encounter in service. The polymer material 28 is surrounded about its outer periphery by a cylinder or retainer wall of an elastic material 26 and its inner periphery by a second cylinder or retainer wall of an elastic material 29. The retainer walls 26 and 29 both contain the polymer 28 in its liquid or melted state, and also can act as a spring, exerting a force to either pull the washers 22 and 24 towards one another or to push them apart. When heated through its melting point, the polymer 28 softens and liquefies, allowing the height of the entire assembly to change.

Referring to FIGS. 3A and 3B, pre-tensioned (pre-compression) shims 10′ and 10″, as depicted, may speed the adjustment time of the shim. If it is known prior to manufacture that all adjustments will require bringing the component to be adjusted closer to the stationary component, then a pre-tensioned shim 10″ shown in FIG. 3B can be used. When heat is applied, the containing material 16 acts as a spring, pulling plates 12 and 14 together. When correct alignment is reached, heat is removed. If it is known prior to manufacture that all adjustments will require the component to be adjusted away from the stationary component, then a pre-compressioned shim 10′ shown in FIG. 3A can be used. When heat is applied, the containing material 16 acts as a spring, pushing the plates 12 and 14 apart. When correct alignment is reached, heat is removed.

When the shims 10′ and 10″ in FIG. 3A and FIG. 3B are themselves produced, prior to their use in manufacture, they start out as cylinders as shown in FIGS. 1A and 1B. The polymer material 18 is then melted and a tension or compression force is applied to the plates 12 and 14 so that when polymer material 18 is later melted, the shims 10′ and 10″ then relax back in the desired direction.

Although the heating element 27 is shown embedded in the polymer 18 in FIGS. 2A and 2B, a heating element 57 of an alternate embodiment shim 50 shown in FIGS. 5A and 5B is printed on an inner surface of at least one of the plates 52 and 54. As in with the embodiment illustrated in FIGS. 1A and 1B, the shim 50 includes upper and lower plates 52 and 54 abutting or mounted to adjustable and fixed components 51 and 53. An elastic retainer wall 56 extends between the plates 52 and 54 defining a volume. A cylinder of polymer material 58 is positioned within the volume and, when in its melted or liquid state, is retained by retaining wall 56. In operation, the heating element receives current from a lead 59 extending from the heating element 57 to the exterior of the shim 50.

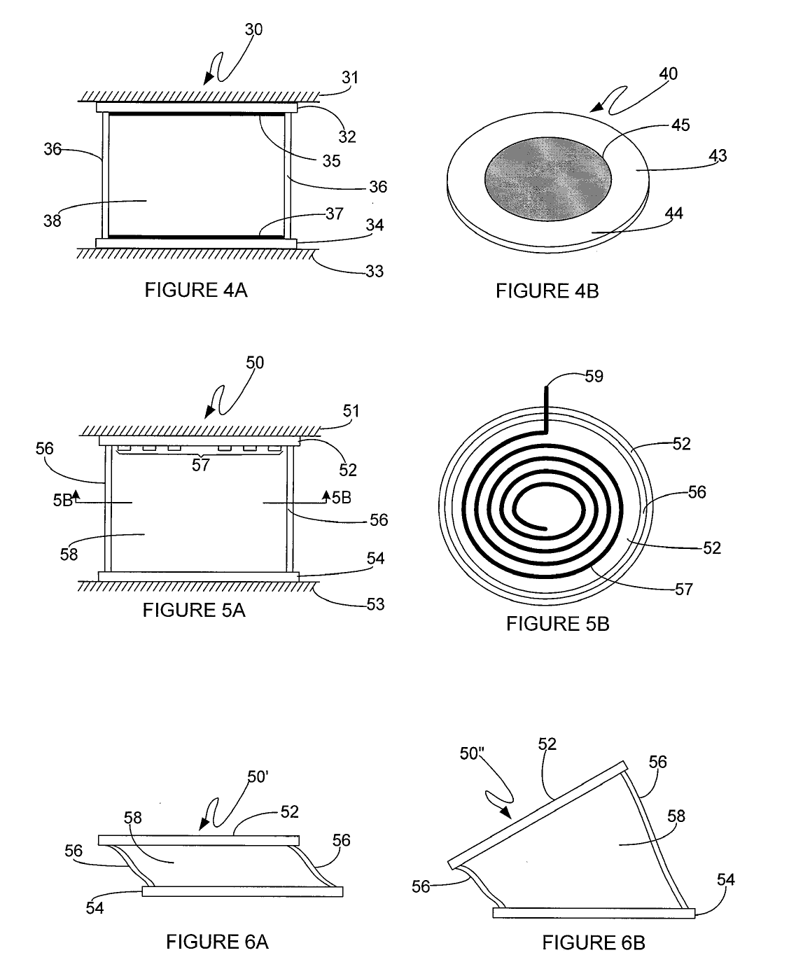

Many thermoplastic materials change their transmissivity at phase change—for example going from opaque white when solid to transparent when liquid. Whether heat is applied externally or internally by an internal heating element, the person doing the alignment can use this property of the thermoplastic material to check whether enough heat has been applied to the thermoplastic material to place it in its melted or liquid state. Alternately, as illustrated in FIG. 4A, a black coating 35 and 37 can be applied on the interior surfaces of the plates 35 and 37. In this case the phase transition becomes obvious when the appearance of the polymer material 38 changes from white to black, polymer material 38 has melted. Like the shim 10 of FIG. 1A, the shim 30 of FIG. 4A includes plates 32 and 34 abutting or mounted to fixed or adjustable components 31 and 33. Extending between the plates 52 and 54, is a flexible retaining wall 56, which retains the polymer in its melted state.

In conjunction with the application of an observable indicator as discussed above, an automatic mechanism can apply heat while using a light sensor to monitor the state of the polymer, immediately withdrawing heat or electric current as soon as the polymer 38 becomes liquid. This offers a means for quicker adjustment in a production setting, since the amount of time to wait for the polymer 38 to melt and solidify is minimized. In addition, a more subtlety application of heat is possible, as a light detector can be used to make a finer distinction, recognizing a phase or state change in the polymer 38 more quickly.

In support of the automatic sensing, FIG. 4B illustrates concentric rings of multiple colors 43 and 45 printed on the inside of the element 44. If heat is applied from outside, it is possible for a human user or automatic apparatus to observe the melting of the polymer from the outer edges (when the color is predominantly 45 towards the center).

So far the discussion has been limited to adjustments up or down. However, instead of an adjustment in only one dimension, alignment along multiple axes is possible. The same mechanism of melting and freezing some contained material can be applied to other adjustment tasks. In FIG. 6A, movement of the plates 52 and 54 is shown in the horizontal direction relative to one another.

However, as depicted in FIG. 6B, the plates 52 and 54 can be translated in three directions (north/south, east/west, and up/down) with respect to one another. The plates 52 can also be twisted slightly about each of their axes, giving three additional degrees of freedom when the polymer 38 is melted. As before, the re-freezing of polymer locks the position of the plates relative to one another.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. An adjustable shim for aligning a component of a device comprising,
first and second plates, the first plate being operably coupled to the component to be aligned,
an adjustable retainer wall extending between the first and second plates and enclosing a volume there between, and
thermoplastic material positioned within the volume, wherein the thermoplastic material has a melting temperature that exceeds the operating temperature of the component to be aligned.

2. The shim of claim 1 wherein the second plate is mountable to a chassis of the device.

3. The shim of claim 1 farther comprising a second adjustable retainer wall extending between the first and second plates and forming an inner wall of the volume enclosed by the first and second plates and first and second retaining walls.

4. The shim of claim 3 further comprising holes in the first and second plates that are co-axial with an inner volume enclosed by the second retainer wall forming a passageway through the first and second plates and second retaining wall.

5. The shim of claim 1 wherein the first and second plates are movable in a direction away from one another when the thermoplastic material is in a melted state.

6. The shim of claim 1 wherein the first and second plates are movable in a direction toward one another when the thermoplastic material is in a melted state.

7. The shim of claim 1 further comprising an auto adjustment component adapted to automatically move the first and second mounting plates in a predetermined direction when the thermoplastic material is in a melted state.

8. The shim of claim 7 wherein the auto adjustment component is the retainer wall in a pre-tensioned state.

9. The shim of claim 1 further comprising a heating element position within the volume.

10. The shim of claim 10 where in the heating element is attached to one of the first or second plates.

11. The shim of claim 1 further comprising a color indicator applied to one of the first or second plates.

12. The shim of claim 11 further comprising a light sensor element operably coupled to the shim to control the heating and cooling of the thermoplastic material based on light sensed by the sensor.

13. The shim of claim 1 wherein the first and second plates and the retaining wall form a generally cylindrically shaped shim.

14. The shim of claim 1 wherein the retaining wall, the second retainer wall, and the first and second plates form a shim having generally cylindrical annulus shape.

15. The shim of claim 1 wherein the device is a television.

16. The shim of claim 15 wherein the component to be aligned is an image engine of the television.

17. A method of aligning a component within a device comprising the steps of
mounting a component to be aligned to an adjustable shim comprising a thermoplastic material having a melting temperature that exceeds the operational temperature of the component to be aligned,
mounting the shim to a chassis of the device,
positioning the device within a tool defining a predetermined alignment of the component to be aligned,
heating the thermoplastic material to a melted state,
adjusting the alignment of the component to the predetermined alignment set by the tool while the thermoplastic material is in a melted state, and
cooling the thermoplastic material to fix the shim and component in the adjusted position.

18. The method of claim 17 wherein an adjusting component causes automatic position adjustment of the component while the thermoplastic material is in a melted state.

19. The method of claim 17 wherein the shim is in a pre-tension state prior to melting the thermoplastic material.

20. The method of claim 17 further comprising the step of sensing a color indicator indicating the shim is in an adjustable state.
